(19) United States
(12) Patent Application Publication
(10) Pub. No.: US 2007/0283608 A1
(43) Pub. Date: Dec. 13, 2007

(54) Key ring display device

(76) Inventor: Gary Gunderson, Orem, UT (US)

Correspondence Address: J. David Nelson;NELSON, SNUFFER, DAHLE & POULSEN, P.C., 10885 South State Street, Sandy, UT, 84070, US

(21) Appl. No.: 11/448,269

(22) Filed: Jun. 7, 2006

(51) Int. Cl. G09F 15/00

(52) U.S. Cl. 40/634

(57) ABSTRACT

A key ring display device a key ring receptacle and a display tab, the display tab having a first display field with a three dimensional display element and a second display field with a written information display element.

### BACKGROUND OF THE INVENTION

This invention is in the field of key holder devices and in particular in the field of key holders with a key ring and with information display.

The use of key holder devices for the retention and use of keys and the simultaneous display of information, particularly advertising, is known in the art. Key rings attached to key tabs which display information regarding individuals or entities are known in the art. Key ring tabs preprinted with automobile dealership information are commonly distributed by automobile dealerships. Unfortunately, as the result of wide scale use, such devices have minimal commercial advertising value since they are so commonplace and are largely ignored by typical observers.

An objective of the present invention is to provide a key ring display device which will enhance the dissemination of information regarding an individual, company or product featured on the display device.

A further objective of the present invention is to provide a key ring display device which will enhance the advertising value and effectiveness of key ring display advertising.

### SUMMARY OF THE INVENTION

A preferred embodiment of a key ring display device of the present invention which is comprised of a ring receptacle and a display tab is shown. The display tab has a first display field and a second display field. A three dimensional display element is affixed to the first display field and a written information display element is affixed to the second display field.

The three dimensional display element is primarily intended to attract the attention of an observer to the key ring display device. For advertising applications of the present invention, the three dimensional display element can be a mere attention attraction or can include an individual, entity or product identifier which is affixed to the three dimensional display element. Likewise the first display field can have a three dimensional display element affixed to the first display field or the first display field can be a blank with the three dimensional display element specifically designed or selected for an intended user or class of users and affixed to the first display field.

The written information display element is primarily intended to present information to an observer to encourage or facilitate the observer in making contact with an individual or entity identified or to encourage or facilitate the observer to seek out a product identified in the written information display element. A business card presentation or a product label presentation would be a typical intended use of the written information display element. Such a business card or product label presentation can be permanently affixed to or integral with the second display field.

The ring receptacle can be a ring loop affixed to the tab top of the display tab by insertion in a tab receptacle. Alternative embodiments may provide for the ring receptacle to comprise a ring loop affixed to the display tab by being imbedded in display tab and a key ring itself can be directly inserted through the imbedded ring loop.

### BRIEF DESCRIPTION OF THE DRAWINGS

FIG. 1 is a front view perspective of a preferred embodiment of a key ring display device of the present invention.

FIG. 2 is a rear view perspective of a preferred embodiment of a key ring display device of the present invention.

FIG. 3 is a perspective detail of a card holder option for a second display field of the key ring display device of the present invention.

### DETAILED DESCRIPTION

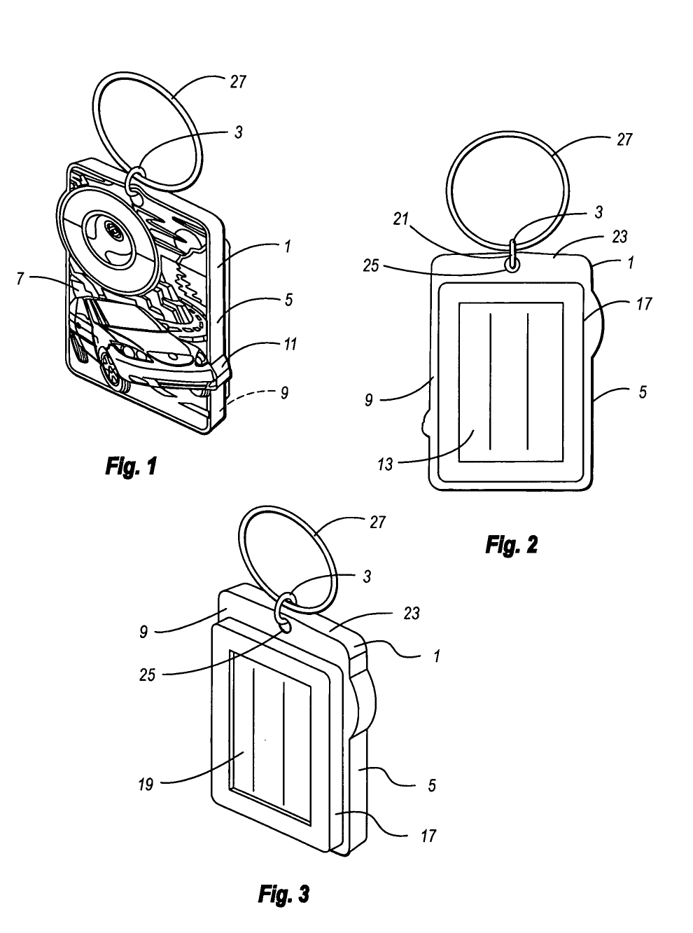

Referring first to FIG. 1, a preferred embodiment of a key ring display device 1 of the present invention which is comprised of a ring receptacle 3 and a display tab 5 is shown. Referring also to FIG. 2, for this embodiment, the display tab has a first display field 7 and a second display field 9. A three dimensional display element 11 is affixed to the first display field and a written information display element 13 is affixed to the second display field. The three dimensional display element can be affixed to the first display field by being imbedded in, attached to, integral with or otherwise affixed to the first display field. Likewise, the written information display element can be affixed to the second display field by being imbedded in, attached to, integral with or otherwise affixed to the second display field.

The three dimensional display element is primarily intended to attract the attention of an observer to the key ring display device. For advertising applications of the present invention, the three dimensional display element can be a mere attention attraction or can include an individual, entity or product identifier 15 which is imbedded in, attached to, integral with or otherwise affixed to the three dimensional display element 11. Likewise the first display field can have a three dimensional display element affixed to the first display field or the first display field can be a blank with the three dimensional display element specifically designed or selected for an intended user or class of users and affixed to the first display field.

The written information display element 13 is primarily intended to present information to an observer to encourage or facilitate the observer in making contact with an individual or entity identified or to encourage or facilitate the observer to seek out a product identified in the written information display element. A business card presentation or a product label presentation would be a typical intended use of the written information display element. Such a business card or product label presentation can be permanently affixed to or integral with the second display field.

Referring also to FIG. 3, a card holder 17 with a transparent card cover 19 can also be affixed to the second display field 9. Such a card holder provides for the insertion and retention of a business card or other written information.

The ring receptacle 3 shown in FIGS. 1-3 is a ring loop 21 affixed to the tab top 23 of the display tab 5 by insertion in a tab receptacle 25. Alternative embodiments may provide for the ring receptacle to comprise a ring loop affixed to the display tab by being imbedded in display tab and a key ring 27 itself can be directly inserted through the imbedded ring loop. Other ring attachment means will be known to persons skilled in the art. Other embodiments of ring attachment means may also provide for one or more additional ring receptacles to be affixed to integral with the display tab. Such additional ring receptacles can be affixed to the bottom or other positions on the periphery of the display tab.

Other embodiments and other variations of the embodiments described above will be obvious to a person skilled in the art. Therefore, the foregoing is intended to be merely illustrative of the invention and the invention is limited only by the following claims and the doctrine of equivalents.

What is claimed is:

1. Key ring display device comprising:
a) display tab having a tab top and a first display field;
b) ring receptacle affixed to the tab top; and
c) three dimensional display element affixed to the first display field.

2. Key ring display device as recited in claim 1 further comprising a second display field.

3. Key ring display device as recited in claim 2 further comprising a written information display element affixed to the second display field.

4. Key ring display device as recited in claim 3 wherein the written information display element comprises a card holder affixed to the second display field.

5. Key ring display device comprising:
a) display tab having a first display field;
b) ring attachment means affixed to the display tab; and
c) three dimensional display element affixed to the first display field.

6. Key ring display device as recited in claim 5 further comprising a second display field.

7. Key ring display device as recited in claim 6 further comprising a written information display element affixed to the second display field

8. Key ring display device as recited in claim 7 wherein the written information display element comprises a card holder affixed to the second display field.

9. Key ring display device as recited in claim 5 wherein the ring attachment means comprises one or more ring receptacles affixed to the periphery of the display tab.

10. Key ring display device comprising:
a) display tab having a tab top and a first display field;
b) ring receptacle affixed to the tab top;
c) three dimensional display element affixed to the first display field; and
d) second display field.

11. Key ring display device as recited in claim 10 wherein the second display field further comprises a written information display element.

12. Key ring display device as recited in claim 11 wherein the written information display element comprises a card holder affixed to the second display field.

13. Key ring display device comprising:
a) display tab having a first display field and a second display field;
b) ring attachment means affixed to the display tab;
c) three dimensional display element affixed to the first display field; and
d) second display field.

14. Key ring display device as recited in claim 13 wherein the second display field further comprises a written information display element.

15. Key ring display device as recited in claim 14 wherein the written information display element comprises a card holder affixed to the second display field.

16. Key ring display device as recited in claim 13 wherein the ring attachment means comprises one or more ring receptacles affixed to the periphery of the display tab.
